(19) United States
(12) Patent Application Publication
(10) Pub. No.: US 2001/0039653 A1
(43) Pub. Date: Nov. 8, 2001

(54) Program conversion method, program conversion apparatus, storage medium for storing program conversion program and program conversion program

(75) Inventor: Roh Egashira, Tokyo (JP)

Correspondence Address: David A. Blumenthal, FOLEY & LARDNER, Suite 500, 3000 K Street, N.W., Washington, DC, 20007-5109, US

(73) Assignee: NEC CORPORATION

(21) Appl. No.: 09/729,773

(22) Filed: Dec. 6, 2000

(30) Foreign Application Priority Data
Dec. 7, 1999 (JP) 11-348104

(51) Int. Cl. G06F 9/45

(52) U.S. Cl. 717/9; 717/7

(57) ABSTRACT

In a program conversion method, a source program is compiled into a temporary re-allocable object program capable of being allocated for each procedure and it is executed in order to collect dynamic information concerning the procedure. Memory access information shows a relative position in the procedure including an instruction code actually taken out. Concerning all procedures, when an area exists in which there are sequential instruction codes corresponding to memory access, the area is determined as an effective area and when plural areas exist, a minimum area including the plural areas is determined as an effective area. Based on the dynamic information, it is determined which memory area in the main memory keeps the procedure not so as to generate a cache conflict of effective areas on a cache line. Based on a determination result, an object program is generated.

### BACKGROUND OF THE INVENTION

1. Field of the Invention

The present invention relates to a program conversion method, a program conversion apparatus, a storage medium for storing a program conversion program and a program conversion program more particularly to the program conversion method, the program conversion apparatus, the storage medium for storing the program conversion program and the program conversion program for converting (compiling) a source program written in a programming language into an object program written in a language (such as a machine language and an assembly language) executable by a computer or a CPU (Central Processing Unit).

The present application claims the priority based on Japanese Patent Application No. Hei 11-348104 filed on Dec. 7, 1999, which is herein incorporated by reference.

2. Description of the Related Art

A program conversion apparatus converts (compiles) a source program written in a programming language into an object program written in a language (such as a machine language and an assembly language) executable by a computer or a CPU (Central Processing Unit). When the object program generated by the program conversion apparatus is executed by a one-chip micro-computer including the CPU, a decoder and a like, the object program is stored in an external main memory, each code of the object program is sequentially read and is decoded by the decoder, and then the CPU interprets each decoded code and executes it. In this case, in order to make an execution speed of the CPU higher, the one-chip micro-computer is provided with a cache memory having a small memory capacity and a short access time for temporarily storing codes read from the external main memory having a large memory capacity and a long access time.

There are some types of the one-chip micro-computer having a cache memory and, in such one-chip micro-computer, when the CPU executes codes, only after memorizing each code of the object program read from the main memory in a cache memory once, the decoder decodes each code and then the CPU interrupts and executes each code. In this type of one-chip micro-computer, there are various techniques of memorizing each code read from the main memory in the cache memory, and one of these techniques is a direct map system.

In direct map system, as shown in FIG. 8, a cache memory 1 is divided to plural memory areas (cache lines), each memory area of a main memory 2 is divided, and each memory area of the main memory 2 corresponds each cache line of the cache memory 1. In FIG. 8, the main memory 2 has eight cache lines, cache line 1a to cache line 1h. In order to correspond to the cache memory 1, the main memory 2 is divided to eight memory areas, each of which has a same memory capacity of one cache line and corresponds to each of cache line 1h to cache line in as a unit having eight memory areas.

In other words, a group of memory area 2₁ₐ to memory area 2₁ₕ in the main memory 2 corresponds to cache line 1a to cache line 1h, a group of memory area 2₂ₐ to memory area 2₂ₕ in the main memory 2 corresponds to cache line 1a to cache line 1h, and a last group of memory area 2ₙₐ to memory area 2ₙₕ (where n is a natural number).

However, there are the following inconveniences when the program conversion apparatus produces the object program to be executed by the one-chip micro-computer using such the direct map system.

For example, as a result of compiling source program written in C language (a registered trademark name) shown in FIG. 9 into the object program by the program conversion apparatus, as shown in FIG. 10, it is assumed that an instruction code of each of a procedure func_A and a procedure func_B is memorized in the main memory 2.

Now, a procedure such as the procedure func_A, the procedure func_B (shown in FIG. 9) or a like is a group of processes executed by the computer or the CPU (for example, addition, subtraction, multiplication and division or a like) and there are cases in that the procedure is called a function or a subroutine. In this specification, a procedure is used as a general name.

In FIG. 10, instruction codes of the procedure func_A are memorized in memory area 2₁ₐ to memory area 2_{1c} in the main memory 2 and instruction codes of procedure func_B are memorized in the memory area 2₂ₐ and the memory area 2_{2b} in the main memory 2. Accordingly, the instruction codes of procedure func_A correspond to cache line 1a to cache line 1c in the cache memory 1 and instruction codes of procedure func_B correspond to cache line 1a and cache line 1b in the cache memory 1.

In this case, when the CPU executes the object program compiled from the source program shown in FIG. 9, first, instruction codes of procedure func_A are read from memory area 2₁ₐ to memory area 2_{1c} in the main memory 2 and once memorized in cache line 1a to cache line 1c in the cache memory 1. Then, the decoder decodes the instruction codes and the CPU interrupts and executes them.

Then, instruction codes of the procedure func_A are read from the memory area 2₂ₐ and the memory area 2_{2b} in the main memory 2 and are memorized in the cache line 1a and the cache line 1b in the cache memory 1. At that time, in spite of that a part of instruction codes of the procedure func_A is already memorized in the cache line 1a and the cache line 1b in the cache memory 1, instruction codes of the procedure func_B are memorized (overwritten), therefore, it is impossible to read the part of instruction codes of the procedure func_A after that. Then, the decoder decodes instruction codes of procedure func_B memorized in the cache line 1a and cache line 1b in the cache memory 1 and the CPU interprets and executes them.

According to the source program shown in FIG. 9, instruction codes of procedure func_A must be executed again, however, instruction codes of procedure func_B are already memorized in the cache line 1a and the cache line 1b in the cache memory 1 and the part of instruction code of procedure func_A can not read, therefore, the part of instruction code of procedure func_A is read again from the memory area 2₁ₐ and the memory area 2_{1b} in the main memory 2 and is memorized in the cache line 1a and the cache line 1b in the cache memory 1 once and the CPU interprets and executes it.

As explained above, when instruction codes of two procedures having a high possibility of being successively executed concerning time are memorized in memory areas in the main memory 2 corresponding to same cache lines in the cache memory 1 (instruction codes are on a same cache line), all or a part of instruction codes of the procedure previously read from the main memory 2 and memorized in the cache memory 1 is overwritten by instruction codes of the procedure successively read from the main memory 2 on same cache lines in the cache memory 1, therefore, it is impossible to read the instruction codes of the procedure previously memorized. This state is called a “cache conflict”. When this cache conflict occurs frequently, not only positive effects of the cache memory 1 provided in order to make an execution speed of the CPU faster are reduced: but also the execution speed of the CPU adversely becomes slower in some cases.

As general other techniques of memorizing each code read from the main memory 2 in the cache memory 1, except for the direct map system, there are a full associative system in which data in a main memory 2 may be memorized in any cache line of the cache memory 1, a set associative system, that is, a middle system of the direct map system in which there is a plurality of cache lines capable of memorizing data of the main memory 2 in the cache memory 1 or a like. Because a memory capacity of the cache memory is smaller than that of the main memory in any system, the above-explained conflict on the cache memory may occur.

Also, concerning procedures frequently used during object program execution, there are cases in that no instruction code is memorized in the cache memory 1 and the instruction code can not be read by the above-mentioned conflict (both are called a cache error), therefore, the instruction code is read from the main memory 2 and is memorized in a corresponding cache line in the cache memory 1 whenever the CPU uses the instruction code. Thus, it is impossible to make the execution speed of the CPU higher.

So, in order to solve the above-mentioned inconveniences of the cache conflict and the cache error of procedures, the applicant previously disclosed a program conversion apparatus in Japanese Patent Laid-open No. Hei 11-232117.

FIG. 11 is a block diagram showing an electrical configuration example of a conventional program conversion apparatus disclosed in Japanese Patent Laid-open No. Hei 11-232117.

The conventional program conversion apparatus is mainly provided with a first program storing section 11, a second program storing section 12, a third program storing section 13, a fourth program storing section 14, a compiler 15, a linker 16, a profiler 17, a first information storing section 18 and a second information storing section 19, an optimizing section 20, a first library storing section 21, a second library storing 22 and a library generating section 23.

First, the library generating section 23 recognizes a procedure unit of each re-allocable library stored in the first library storing section 21 and converts it into a re-allocable library capable of allocating each procedure, and then the re-allocable library is stored in the second library storing section 22. Now, the re-allocable library is one of re-allocable object programs, and the re-allocable object program is an object program capable of being stored in any memory area in a main memory, and a phrase of ‘capable of allocating each procedure’ is that a procedure can be allocated within the re-allocable object program.

The compiler 15 reads a source program written in a programming language written in such as C language from the first program storing section 11, compiles the source program into the re-allocable object program such as a machine language or an assembly language, and then converts the re-allocable object program into the re-allocable object program capable of allocating each procedure and stores it in the second program storing section 12.

With this operation, the linker 16 links the re-allocable object program capable of allocating each procedure stored in the second program storing section 12 and the re-allocable object program capable of allocating each procedure stored in the second library storing section 22, generates a temporary object program executable and stores the temporary object program in the third program storing section 13. Now, the temporary object program is an object program that a source program is converted into codes including machine languages or assembly language in description order of the source program against a last object program optimized effectively concerning execution time.

Then, the profiler 17, while executing the temporary object program read from the third program storing section 13, collects dynamic information (profile information) including calling relationships among respective procedures, a number of calls for each procedure, loop structure information and stores the collected dynamic information in the first information storing section 18.

With this operation, the optimizing section 20, based on the dynamic information stored in the first information storing section 18, optimizes allocation for all procedure by a cache line coloring so that a cache conflict does not occur in procedures having a high possibility of being executed successively concerning time on a cache memory and a cache error of procedure used frequently occurs, generates allocation information to instruct the allocation to the linker 16 and stores the allocation information in the second information storing section 19.

Accordingly, the linker 16, based on the allocation information stored in the second information storing section 19, generates a last executable object program by linking a re-allocable object program capable of allocating each procedure and a re-allocable object library capable of allocating each procedure.

FIG. 12 to FIG. 14 show an example of procedures included in a source program written in C language. As understood from FIG. 12, priority may be equal since a procedure func_10 and a procedure func_20 exist in a procedure func_0 in a same loop.

Concerning these procedures, when the program conversion apparatus optimizes procedure allocation by cache line coloring based on dynamic information including calling relationships among procedures, a frequency of calls for each procedure and loop structure information, as shown in FIG. 15, procedure func0, procedure func_10 and procedure func_20 are arranged.

In other words, instruction codes of the procedure func0 are stored in memory area 2₂ₐ to memory area 2_{2f} in main memory 2 and correspond to cache line 1a to cache line 1f, instruction codes of the procedure func_10 are stored in memory area 2_{2g} and the memory area 2₂ₕ in main memory 2 and correspond to the cache line 1g and the cache line 1h and instruction codes of the procedure func_20 are stored in memory area 2₁ₑ to memory area 2₁ₕ in the main memory 2 and correspond to cache line 1e to cache line 1h.

As described above, according to the configuration of the example, it is possible to prevent the cache conflict among various procedures on a cache memory from occurring and to prevent the cache error of the procedures used frequently. Therefore, execution speed can be increased when the computer or the CPU executes the object program.

Now, there are procedures such as error processing, exception processing or interrupt processing executed only when abnormality, urgent situation or special situation occurs in a one-chip micro-computer and there are procedures which change flow of the program, for example, in an if-else sentence, there are branches in an instruction, and when a condition is satisfied, processes after ‘if’ before ‘else’ are executed and in other cases, process after ‘else’ are executed. In the above-mentioned procedure func0, as shown in FIG. 12, since processes after ‘else’ are error processing, the error processing is not executed so long as the one-chip micro-computer operates normally. Also, in the above-mentioned procedure func_10 and the procedure func_20, there are branches in instructions, therefore, when a condition (flag1==OK, flag2==OK) is satisfied, processes after ‘if’ before ‘else’ shown in FIG. 13 and FIG. 14 are executed, and in other cases, processes after ‘else’ are executed.

Accordingly, concerning these procedures, when allocation optimization is executed while these procedures are made as a group, the cache conflict and the cache error of the procedures will occur formally, however, the cache conflict and the cache error of the procedures hardly occur substantially. In the example shown in FIG. 15, for example, when processes in respective procedures usually not executed are stored in the memory area 2₁ₕ, the memory area 2₂ₑ, the memory area 2_{2f} and the memory area 2₂ₕ with slanted lines in the main memory 2, the cache conflict and the cache error of the procedures hardly occur substantially, therefore, it is unnecessary to consider these in allocation optimization.

However, in the above-mentioned conventional program conversion apparatus, the above circumstances are not considered, and allocation optimization is executed while all procedures are made as a group, therefore, allocation optimization is executed not only for processes in which the cache conflict and the cache error of procedures may occur but also for processes in which the cache conflict and the cache error of procedures hardly occur substantially. Thus, there is a limit to promote efficiency of the object program.

With this reason, there is a disadvantage in that the above-mentioned conventional program conversion apparatus is not suitable for a program used for an apparatus, such as a mobile tool in recent years, dealing with a large quantity of data at high speed and tightly requiring to prevent the cache conflict and the cache error of procedures.

In addition, it is impossible to completely prevent the cache conflict and the cache error of procedures from occurring even if a technique of allocation optimization of procedures is used in the above-mentioned conventional program conversion apparatus. Explanations will be given of reasons using examples of FIG. 12 to FIG. 15 as follows.

As understood from FIG. 12, a frequency which the procedure func0 calls the procedure func_10 is 10,000 times and a frequency which the procedure func0 calls the procedure func_20 is 10,000 times. In other words, a frequency is usually expressed as 10,000 times per operation(unit). It is assumed that it takes 50 clocks to execute the procedure func_10 once without the cache error, it takes 150 clocks to execute the procedure func_20 once without the cache error and it takes 200 clocks to execute other processes except for the procedure func_10 and the procedure func_20 in the procedure func0 once without the cache error. Accordingly, to execute all processes of the procedure func0 once without the cache error, it takes 2,000,200 clocks (=200+10000×(50+150)).

Under this condition, it is assumed that there is a loss of 50 clocks whenever the cache error occurs. Then, though the allocation optimization of procedures in the conventional technique is executed, as understood from FIG. 15, the cache conflict occurs in the cache line 1e and the cache line 1f between the procedure func0 and the procedure func_20. Therefore, in the procedure func0, when the cache conflict occurs between process calling the procedure func_20 and the procedure func_20 in itself, the cache error occurs when the procedure func_20 is called and when a process is returned from the procedure func_20 to the procedure func0.

Accordingly, when it is assumed that one cache error occurs when the procedure func_20 is called in the procedure func0 and one cache error occurs when process is returned from the procedure func_20 to the procedure func0 and all processes of the func0 are executed, cache errors of 20,000 times, therefore, a loss of 1,000,000 clocks (=50×20,000)is produced. Also, when the procedure func0 is executed first, dozens of cache errors occur and a loss produces in accordance with the cache errors. However, the loss gives no influence to all processes, therefore, the loss is not considered.

### SUMMARY OF THE INVENTION

In view of the above, it is an object of the present invention to provide a program conversion method, a program conversion apparatus, a storage medium storing a program conversion program and the program conversion program capable of preventing a cache conflict among various procedures in a cache memory and a cache error of procedures used frequently from occurring substantially, and thereby capable of making an execution speed higher when a computer or a CPU executes an object program.

According to a first aspect of the present invention, there is provided a program conversion method of converting a source program written in a programming language into a first object program written in a language executable by a computer and a central processing unit, the program conversion method including:

a first step of converting the source program into a second object program;

a second step, while executing the second object program, of collecting information concerning a procedure, a function or a subroutine used in the source program and of generating memory access information showing a relative position of an instruction code actually taken out in the procedure, the function or the subroutine;

a third step, concerning all procedures, all functions or all subroutines in the second object program, of determining an area as the effective area when the an area exists in which there are sequential instruction codes corresponding to the memory access information and of determining an minimum area including plural areas as the effective area when the plural areas exist in which there are sequential instruction codes corresponding to the memory access information; and

a fourth step, based on the memory access information, of determining which storage area keeps the procedure, the function or the subroutine in a main memory in which the first object program is stored when the first object program is used by the computer and the central processing unit, not so as to generate a cache conflict of the effective areas on a cache line in the computer and the central processing unit.

In the foregoing, a preferable mode is one wherein the procedure, the function or the subroutine includes at least one defined by the user in the source program, one already defined and inspected by the user, one previously prepared in a processing system in the programming language and one previously prepared in instruction code format.

Also, a preferable mode is one wherein the memory access information includes information showing a frequency of actual calls for the procedure, the function or the subroutine and information showing a relationship for calling the procedure, the function or the subroutine each other, obtained by executing the second object program.

Furthermore, a preferable mode is one wherein the memory access information is generated only when the instruction code concerning a process changing a flow of the second object program is taken out.

According to a second aspect of the present invention, there is provided a program conversion method of converting a source program written in a programming language into a first object program written in a language executable by a computer and a central processing unit, the program conversion method including:

a first step of converting the source program into a second object program and of generating a third object program by converting a procedure, a function or a subroutine defined by a user in the source program concerning the second object program into a procedure, a function or a subroutine storable in any memory area of an main memory in which the first object program is stored when the first object program is used in the computer or the central processing unit;

a second step of generating a fourth object program by linking the procedure, the function or the subroutine in any memory area in the main memory which is at least a part of one defined and inspected by the user, one previously prepared in a processing system in the programming language or one previously prepared in an instruction code format in the procedure, the function and the subroutine used in the source program with the third object program;

a third step, while executing the fourth object program, of collecting dynamic information including information showing a frequency of actual calls for the procedure, the function or the subroutine and information showing a relationship of calling the procedure, the function or subroutine each other and of generating memory access information showing a relative position in the procedure, the function or the procedure including an instruction code actually taken out;

a fourth step, concerning all procedures, all functions or all subroutines in the fourth object program, of determining an area as an effective area when the area exists in which there are sequential instruction codes corresponding to the memory access information and of determining a minimum area including plural areas as an effective area when the plural areas exist in which there are sequential instruction codes corresponding to the memory access information;

a fifth step, based on the dynamic information, of determining which storage area keeps the procedure, the function or the subroutine in the main memory in which the first object program is stored when the first object program is used by the computer and the central processing unit, not so as to generate a cache conflict of the effective areas on a cache line in the computer and the central processing unit and of generating allocation information; and

a sixth step, based on the allocation information, of generating the first object program by linking a converted procedure, a converted function or a converted subroutine storable in any memory area in the main memory which is at least a part of one defined and inspected by the user, one previously prepared in a processing system in the programming language or one previously prepared in instruction code format in the procedure, the function or the subroutine used in the source program with the third object program.

According to a third aspect of the present invention, there is provided a program conversion method of converting a source program written in a programming language into a first object program written in a language executable by a computer and a central processing unit, the program conversion method including:

a first step of converting the source program into a second object program and of generating a third object program by inserting a code for counting a frequency of actual calls for a procedure, a function or a subroutine when the second object program is executed and by converting a procedure, a function or a subroutine defined by a user in the source program concerning the second object program into a procedure, a function or a subroutine storable in any memory in a main memory in which the first object program is stored when the first object program is used by the computer or the central processing unit;

a second step of generating a fourth object program by linking the procedure, the function or the subroutine storable in any memory area in the main memory which is at least a part of one defined and inspected by a user, one previously prepared in a processing system in the programming language or one previously prepared in instruction code format in the procedure, the function or the subroutine used in the source program with the third object program;

a third step, while executing the fourth object program, of collecting dynamic information including information showing a frequency of actual calls for the procedure, the function or the subroutine and information showing a relationship of calling the procedure, the function or subroutine each other and of generating memory access information showing a relative position in the procedure, the function or the procedure including instruction code actually taken out;

a fourth step, concerning all procedures, all functions or all subroutines in the fourth object program, of determining an area as an effective area when the area exists in which there are sequential instruction codes corresponding to memory access information and of determining a minimum area including plural areas as the effective area when the plural areas exist in which there are sequential instruction codes corresponding to the memory access information;

a fifth step, based on the dynamic information, of determining which storage area keeps the procedure, the function or the subroutine in the main memory in which the first object program is stored when the first object program is used by the computer and the central processing unit, not so as to generate a cache conflict of the effective areas on a cache line in the computer and the central processing unit and of generating allocation information; and

a sixth step, based on the allocation information, of generating the first object program by linking the procedure, the function or the subroutine in any memory area in the main memory which is at least a part of one defined and inspected by the user, one previously prepared in the processing system in the programming language or one previously prepared in the instruction code format in the procedure, the function or subroutine used in the source program with the third object program.

In the foregoing, a preferable mode is one wherein in the third step, the memory access information is generated only when the instruction code concerning a process changing a flow of the second object program is taken out.

According to a fourth aspect of the present invention, there is provided a program conversion apparatus for converting a source program written in a programming language into a first object program written in a language executable by a computer and a central processing unit, the program conversion apparatus including:

a first program converting section for converting the source program into a second object program;

a program executing section, while executing the second object program, for collecting information concerning a procedure, a function or a subroutine used in the source program and for generating memory access information showing a relative position in a procedure, a function or a subroutine including an instruction code actually taken out;

an effective area judging section, concerning all procedures, all functions or all subroutines in the second object program, of judging an area as the effective area when the area exists in which there are sequential instruction codes corresponding to the memory access information and of judging a minimum area including plural areas as the effective area when the plural areas exist in which there are sequential instruction codes corresponding to the memory access information; and

a second program converting section, based on the information, for determining which memory in a main memory keeps the procedure, the function or the subroutine, the main memory storing the first object program when the first object program is used by the computer or the central processing unit, not so as to generate a cache conflict of the effective areas on a cache line in the computer or the central processing unit.

In the foregoing, a preferable mode is one wherein the procedure, the function or the subroutine includes at least one defined by a user in the source program, one already defined inspected by the user, one prepared in a processing system in the programming language and which is prepared in instruction code format.

Also, a preferable mode is one wherein the memory access information includes information showing a frequency of actual calls for the procedure, the function or the subroutine and information showing a relationship for calling the procedure, the function or the subroutine.

According to a fifth aspect of the present invention, there is provided a program conversion apparatus for converting a source program written in a programming language into a first object program written in a language executable by a computer and a central processing unit, the program conversion apparatus including:

a program converting section for converting the source program into a second object program and, concerning the second object program, by converting a procedure, a function or a subroutine defined by a user in the source program into a procedure, a function or a subroutine storable in any memory area of a main memory in which the first object program is stored when the first object program is processed by the computer or the central processing unit, of generating a third object program;

a linker for linking the procedure, the function or the subroutine in any memory area in the main memory which is at least a part of one defined and inspected by a user, one previously prepared in a processing system in the programming language or one previously prepared in an instruction code format in the procedure, the function or subroutine used in the source program with the third object program and for generating a fourth object program;

a memory access information generating section, while executing the fourth object program, for collecting dynamic information including information showing a frequency actual calls for the procedure, the function or the subroutine and information showing a relationship of calling the procedure, the function or the subroutine and for generating memory access information showing a relative position in the procedure, the function or the subroutine including instruction code actually taken out;

an effective area judging section for concerning all procedures, all functions or all subroutines in the fourth object program, of judging an area as the effective area when the area exists in which there are sequential instruction codes corresponding to the memory access information and of judging a minimum area including plural areas as the effective area when the plural areas exist in which there are sequential instruction codes corresponding to the memory access information; and

an optimizing section, based on the dynamic information, for determining which memory in the main memory keeps the procedure, the function or the subroutine, the main memory storing the first object program when the first object program is used by the computer or the central processing unit, not so as to generate a cache conflict of the effective areas on a cache line in the computer or the central processing unit and for generating allocation information; and

the linker, based on the allocation information, for linking the procedure, the function or the subroutine in any memory area in the main memory which is at least a part of one defined and inspected by the user, one previously prepared in the processing system in the programming language or one previously prepared in instruction code format in the procedure, the function or the subroutine used in the source program with the fourth object program and for generating the first object program.

According to a sixth aspect of the present invention, there is provided a program conversion apparatus for converting a source program written in a programming language into a first object program written in a language executable by a computer and a central processing unit, the program conversion apparatus including:

a program converting section for converting the source program into a second object program, for inserting a code counting a frequency of actual calls for a procedure, a function or a subroutine when the second object program is executed, and, concerning second object program, by converting the procedure, the function or the subroutine defined by a user in the source program into a procedure, a function or a subroutine in any memory area of a main memory in which the first object program is stored when the first object program is processed by the computer or the central processing unit, of generating a third object program;

a linker for linking the procedure, the function or the subroutine in any memory area in the main memory which is at least a part of one defined and inspected by the user, one previously prepared in a processing system in the programming language or one previously prepared in instruction code format in the procedure, the function or subroutine used in the source program with the third object program and for generating a fourth object program;

a memory access information generating section, while executing the fourth object program, for collecting dynamic information including information showing a frequency of actual calls for the procedure, the function or the subroutine and information showing a relationship of calling the procedure, the function or the subroutine and for generating memory access information showing a relative position in the procedure, the function or the subroutine including instruction code actually taken out; and

an effective area judging section, concerning all procedures, all functions or all subroutines in the fourth object program, for judging an area as an effective area when the area exists in which there are sequential instruction codes corresponding to the memory access information and for judging a minimum area including plural areas as the effective area when the plural areas exist in which there are sequential instruction codes corresponding to the memory access information; and

an optimizing section, based on the dynamic information, for determining which memory in the main memory keeps the procedure, the function or the subroutine, the main memory storing the first object program when the first object program is used by the computer or the central processing unit, not so as to generate a cache conflict of the effective areas on a cache line in the computer or the central processing unit and for generating allocation information; and

the linker, based on the allocation information, for linking the procedure, the function or the subroutine in any memory area in the main memory which is at least a part of one defined and inspected by the user, one previously prepared in the processing system in the programming language or one previously prepared in an instruction code format in the procedure, the function or subroutine used in the source program with the fourth object program and for generating the first object program.

In the foregoing, a preferable mode is one wherein the program executing section generates the memory access information only when an instruction code concerning a process changing a flow of the second object program is taken out.

According to a seventh aspect of the present invention, there is provided a storage medium storing a program conversion program carrying out functions according to any one of the first aspect to the sixth aspect and preferable modes.

With these configurations, it is possible to prevent a cache conflict among various procedures on a cache memory and a cache error from occurring more substantially. Therefore, it is possible to make an execution speed higher when a computer or a CPU executes an object program.

### BRIEF DESCRIPTION OF THE DRAWINGS

The above and other objects, advantages, and features of the present invention will be more apparent from the following description taken in conjunction with the accompanying drawings in which:

FIG. 1 is a block diagram showing an electrical configuration of a program conversion apparatus according to a first embodiment of the present invention;

FIG. 2 is a flowchart showing an operation of the program conversion apparatus according to the first embodiment of the present invention;

FIG. 3 is a flowchart showing an operation of a memory access information generating section of a profiler in the program conversion apparatus according to the first embodiment of the present invention;

FIG. 4 is a flowchart showing an operation of a procedure effective area judging section of an optimizing section in the program conversion apparatus according to the first embodiment of the present invention;

FIG. 5 is a view showing a relationship between procedures allocated in a main memory by a procedure allocation optimization process with a cache optimizing section in the optimizing section and each cache line in a cache memory in the program conversion apparatus according to the first embodiment of the present invention;

FIG. 6 is a block diagram showing an electrical configuration of a program conversion apparatus according to a second embodiment of the present invention;

FIG. 7 is a block diagram showing an electrical configuration of a program conversion apparatus according to a third embodiment of the present invention;

FIG. 8 is a view explaining a relationship between a cache memory and a main memory in a direct map system in prior art;

FIG. 9 is a view showing an example when a source program is written in C language in prior art;

FIG. 10 is a view explaining a cache conflict among procedures in a cache memory in prior art;

FIG. 11 is a block diagram showing an electrical configuration of a prior art program conversion apparatus;

FIG. 12 is a view showing another conventional example when a source program is written in C language;

FIG. 13 is a view showing an example when a procedure func_10 in the source program shown in FIG. 12 is written in C language;

FIG. 14 is a view showing an example when a procedure func_20 in the source program shown in FIG. 12 is written in C language; and

FIG. 15 is a view showing a relationship between procedures allocated in a main memory by a procedure allocation optimization process with a cache optimizing section in an optimizing section and each cache line in a cache memory in the prior art program conversion apparatus.

### DETAILED DESCRIPTION OF THE PREFERRED EMBODIMENTS

Best modes for carrying out the present invention will be described in further detail using various embodiments with reference to the accompanying drawings.

### First Embodiment

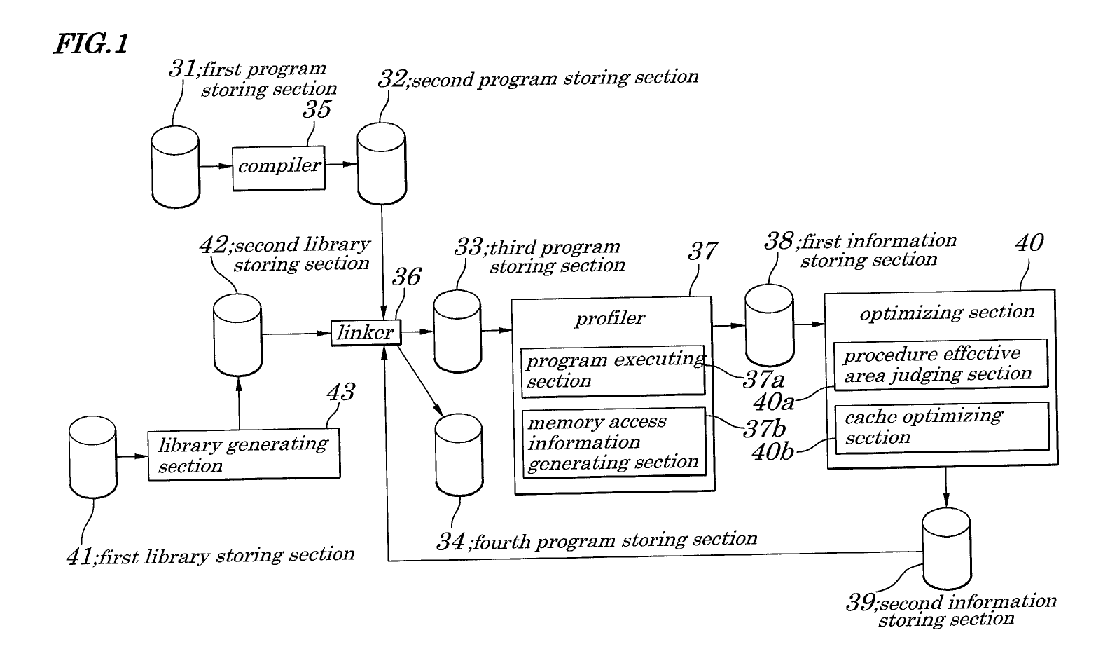

FIG. 1 is a block diagram showing an electrical configuration of a program conversion apparatus according to the first embodiment of the present invention.

The program conversion apparatus according to the first embodiment is mainly provided with a first program storing section 31, a second program storing section 32, a third program storing section 33, a fourth program storing section 34, a compiler 35, a linker 36, a profiler 37, a first information storing section 38, a second information storing section 39, an optimizing section 40, a first library storing section 41, a second library storing section 42 and a library generating section 43.

The first program storing section 31 is a semiconductor memory such as a ROM or a RAM or a storage medium such as an FD (a floppy disc), an HD (a hard disk) or a CD-ROM and previously stores a source program written in a programming language such as C language. In the first embodiment, a case is explained in that C language is used as the programming language. The compiler 35 compiles the source program into a re-allocable object program, and then converts it into a re-allocable object program capable of allocating respective procedures and stores it in the second program storing section 32.

In the first embodiment, a procedure is used as a term including a function, a subroutine in addition to a procedure. The procedure includes a user procedure, a user library procedure, a standard library procedure, a runtime library procedure and a like.

The user procedure is a procedure defined by a user in the source program. The user library procedure is originally a user procedure, however, a procedure, of which generality is high, stored in the first library storing section 41 after a test such as debugging. The standard library procedure is a procedure previously prepared in a processing system such as a compiler in a programming language used in order to describe a source program and capable being used by the user without defining. For example, in C language, there are a procedure “printf” for outputting a character string to an standard output and a procedure “strlen” for cahnging back a length of the character string.

The runntime library procedure is a procedure previously written in instruction codes and stored in the first library storing section 41 since generality is high and a code size is large. Concerning an instruction string of which generality is high and a size is large, it is not efficient that instruction codes are generated whenever the compiler 35 generates an object program, therefore, the instruction string is made in a procedure previously written in the instruction codes and a code calling the procedure, and then they are linked by the linker 36. For example, in spite of that a CPU or like executing a final object program has no instruction for a floating point, when a variable or a operation of a float type is written in the source program, the compiler 35 generates an object program using plural instruction strings such as a procedure “add” for float and a procedure “sub” for float. The procedure “add” and the procedure “sub” for float in this time are included in the runtime library procedure.

The second program storing section 32 is a semiconductor memory such as a RAM or a storage medium such as an FD or an HD and stores a re-allocable object program capable of allocating each procedure. The linker 36 links the re-allocable object program capable of allocating each procedure, stored in the second program storing section 32 and the re-allocable object library capable of allocating each procedure, stored in the second library storing section 42 in order to generate an executable temporary object program and then stores the executable temporary object program in the third program storing section 33. Also, the linker 36, based on allocation information (described later) stored in the second information storing section 39, links the re-allocable object program capable of allocating each procedure and the re-allocable object library capable of allocating each procedure in order to generate an executable final object program and then stores the executable final object program in the fourth program storing section 34. The third program storing section 33 is a semiconductor memory such as a RAM or a storage medium such as an FD or an HD and stores a temporary object program. The fourth program storing section 34 is a semiconductor memory such as a RAM or a storage medium such as an FD or an HD and stores a final object program.

The profiler 37 is a hardware emulator, a software simulator or a like and is mainly provided with a program executing section 37a and a memory access information generating section 37b.

The program executing section 37a, while executing the temporary object program read from the third program storing section 33, collects dynamic information such as a calling relationship among respective procedures, a number of calls for each procedure and loop structure information and stores collected dynamic information in the first information storing section 38 together with memory access information (described later) obtained by the memory access information generating section 37b. The loop structure information is information showing that a procedure is called in a loop structure. Concretely, a marker is written in the loop structure of a source program in order to recognize a start and an end of a loop during operation of the program executing section 37a. Then, the program executing section 37a recognizes the start and the end of the loop structure by the maker while operating, and therefore, it is possible to recognize that the procedure called in the loop structure belongs to the loop structure. With this operation, it is possible to judge a possibility in that procedures in the loop structure are continuously executed.

The memory access information generating section 37b, while the program executing section 37a executes the temporary object program read from the third program storing section 33, generates memory access information based on the procedure allocation information and a like included in the temporary object program and then stores the memory access information in the first information storing section 38 together with the dynamic information obtained in the program executing section 37a as profiler information. Now, the procedure allocation information is, for example, symbol information concerning a global attribute, a procedure attribute or a like added to a top of the procedure showing that the procedure can be used outside of the procedure, and is information showing where the procedure is allocated in a temporary object program.

The first information storing section 38 is a semiconductor memory such as a RAM or a storage medium such as an FD or an HD and stores profile information including the dynamic information and the memory access information.

The optimizing section 40 is mainly provided with a procedure effective area judging section 40a and a cache optimizing section 40b.

The procedure effective area judging section 40a, based on the memory access information read from the first information storing section 38, judges an effectively processed area of each procedure and sets the effectively processed area as a procedure effective area. The cache optimizing section 40b, based on the dynamic information read from the first information storing section 38, allocation-optimizes procedures not so that a conflict or a cache error occurs in the cache memory concerning the procedure effective area obtained by the procedure effective area judging section 40a, and then generates allocation information for instructing allocation of procedures for the linker 36 and stores the allocation information in the second information storing section 39.

The second information storing section 39 is a semiconductor memory such as a RAM and a storage medium such as an FD or an HD and stores the allocation information. The first library storing section 41 is a semiconductor memory such as a ROM or a RAM and a storage medium such as an FD, an HD or a CD-ROM and stores respective re-allocable libraries including standard library procedure, runtime library procedure and user library procedure. The library generating section 43 converts the re-allocable library stored in the first library storing section 41 into a re-allocable library capable of allocating each procedure and stores the re-allocable library capable of allocating each procedure in the second library storing section 42. The second library storing section 42 is semiconductor memory such as a RAM or a storage medium such as an FD or an HD and stores the re-allocable library capable of allocating each procedure.

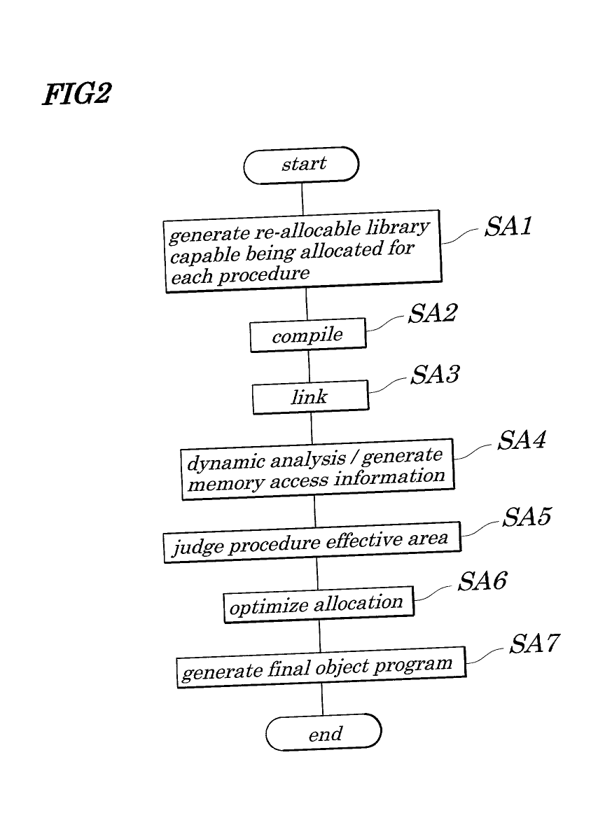

Next, explanations will be given of an operation of the program conversion apparatus with reference to FIG. 2 to FIG. 5.

First, in a step SA1 shown in FIG. 2, the library generating section 43, concerning each re-allocable library stored in the first library storing section 41, recognizes a procedure unit, converts each re-allocable library into a re-allocable library capable of allocating each procedure and stores the re-allocable library capable of allocating each procedure in the second library storing section 42. Plural procedures in one re-allocable library belong to a section which is an allocation unit as a group, for example, a text section (.text·section) and are arranged as a text section in a group during linking by the linker 36, and therefore, it is impossible to allocate the plural procedure per an individual procedure unit. Then, when the plural procedures are divided into individual sections in procedure units, it is possible to allocate the plural procedures in procedure units during linking by the linker 36 appropriately. In addition, please refer to Japanese Patent Application Laid-open No. Hei 11-232117 concerning a technique for dividing text sections in a re-allocable library into sections in procedure units.

In a step SA2, the compiler 35 compiles a source program into a re-allocable object program, and then converts the re-allocable object program into a re-allocable object program capable of allocating each procedure by a same process of the library generating section 43 and stores it in the second program storing section 32.

In a step SA3, the linker 36 links the re-allocable object program capable of allocating each procedure stored in the second program storing section 32 and the re-allocable library capable of allocating each procedure stored in the second library storing section 42 in order to generate an executable temporary object program and stores the executable temporary object program in the third program storing section 33.

In a step SA4, the program executing section 37a in the profiler 37 collects dynamic information including a calling relationship among procedures, a frequency of calls for each procedure, loop structure information and a like while executing the temporary object program read from the third program storing section 33. Synchronously, the memory access information generating section 37b, while executing the temporary object program read from the third program storing section 33 by the program executing section 37a, generates memory access information based on procedure allocation information or a like included in the temporary object program.

Then, the program executing section 37a and the memory access information generating section 37b memorize the dynamic information and the memory access information obtained by respective processes in the first information storing section 38 as profile information.

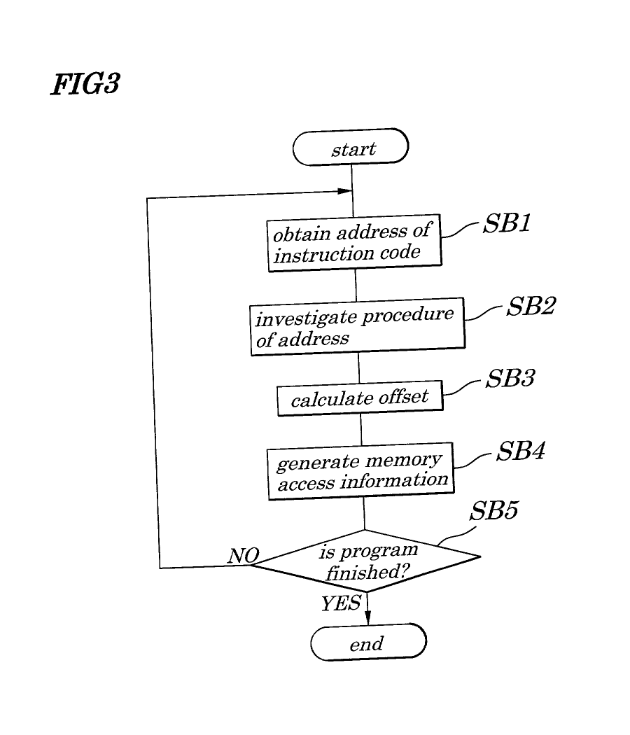

Now, explanations will be given of a memory access information generating process executed by the memory access information generating section 37b with reference to a flowchart shown in FIG. 3.

First, in a step SB1, whenever the program executing section 37a takes out (fetches) an instruction code in the temporary object program from the third program storing section 33, the memory access information generating section 37b obtains an address (absolute address) of the instruction code from a program counter, and then advances to a step SB2.

In the step SB2, the memory access information generating section 37b investigates which procedure includes the address of the instruction code obtained in the process of the step SB1 by referring to the procedure allocation information included in the temporary object program and showing where the procedure is allocated in the temporary object program and then advances to a step SB3.

In the step SB3, the memory access information generating section 37b calculates an instruction offset by subtracting a top address (absolute address) of the procedure obtained as a result of the investigation in the step SB2 from the address obtained by the process in the step SB1, and then advances to a step SB4.

In the step SB4, the memory access information generating section 37b converts the address obtained by the process in the step SB1 into memory access information having a form of “procedure name_instruction offset”, and then advances to a step SB5.

In the step SB5, the memory access information generating section 37b judges whether the temporary object program executed by the program executing section 37a is finished or not. When the judgment result is “NO”, the process is returned to the step SB1. The processes from the step SB1 to the step SB4 are repeated until the temporary object program executed by the program executing section 37a is finished. Then, when the temporary object program executed by the program executing section 37a is finished, the judgment result in the step SB5 is “YES” and the memory access information generating section 37b finishes serial processes.

In a step SA5 (FIG. 2), the procedure effective area judging section 40a in the optimizing section 40, based on the memory access information in the profile information read from the first information storing section 38, judges an area effectively processed of each procedure and sets the area as a procedure effective area of each procedure.

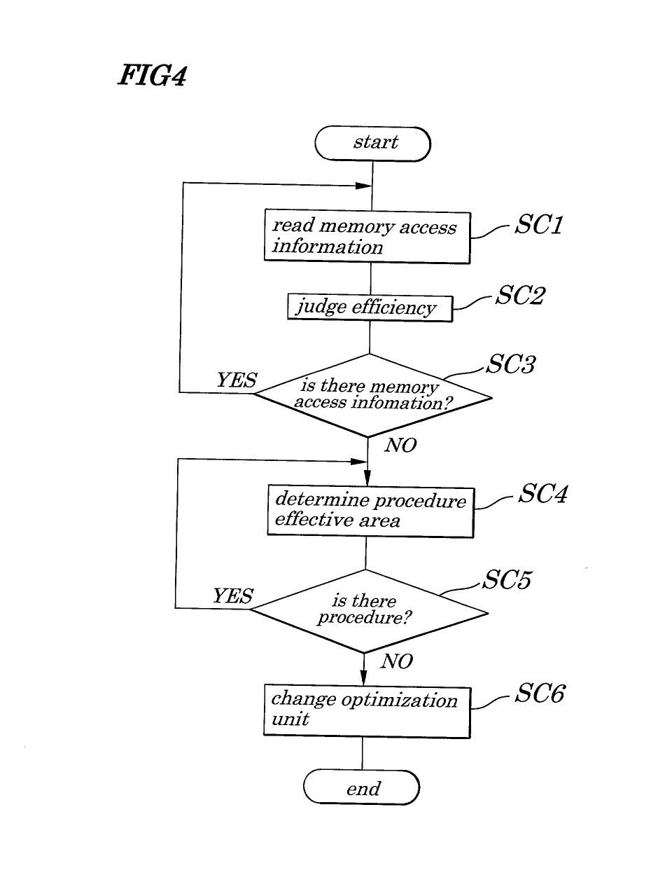

Now, explanations will be given of a procedure effective area judging process executed by the procedure effective area judging section 40a with reference to a flowchart shown in FIG. 4.

First, in a step SC1, the procedure effective area judging section 40a reads a piece of memory access information from the first information storing section 38, and then advances to a step SC2. In the step SC2, a instruction code of an address of a procedure corresponding to the memory access information read in the step SC1 is judged as an effective instruction code which is actually used during program execution, and then a process is advanced to a step SC3. In the step SC3, it is judged whether there is memory access information to be read by the first information storing section 38. When this judgment result is “YES”, the process is returned to the step SC1 and the processes of the step SC1 and the SC2 are repeated. On the other hand, if all memory access information is read from the first information storing section 38, and therefore, when there is no memory access information to be read in the first information storing section 38, the judgment result in the step SC3 is “NO”, and then a process is advanced to a step SC4.

In the step SC4, concerning a procedure, an address area in which instruction codes judged as effective instruction codes sequentially exist is determined as a procedure effective area. For example, when there are plural “if-else” sentences and processes after “if” before “else” are executed, that is, when, concerning a procedure there are plural address areas in which instruction codes determined as effective codes sequentially exist, a minimum address area including all of them is determined as a procedure effective area, and then a process is advanced to a step SC5. In the step SC5, it is judged whether there is another procedure in the temporary object program memorized in the third program storing section 33 or not. When this judgment result is “YES”, the process is returned to the step SC4 and the step SC4 is repeated. On the other hand, the process in the step SC4 is executed for all procedures in the temporary object program stored in the third program storing section 33, therefore, when there is no procedure to be processed, the judgment result is “NO” and the process is advanced to a step SC6. In the step SC6, an optimization unit to be optimized in the cache optimizing section 40b is changed from a procedure to the procedure effective area determined in the process of the step SC4, and then a series of processes is finished.

In a step SA6 (FIG. 2), the cache optimizing section 40b in the optimizing section 40, based on the dynamic information read from the first information storing section 38, executes allocation optimization for all procedure not so that a cache conflict or a cache error occurs on a cache memory in setting the procedure effective area determined by the procedure effective area judging section 40a as an optimization unit, generates allocation information for instructing procedure allocation for the linker 36 and stores the allocation information in the second information storing section 39. In addition, the allocation optimization, except for that optimization is executed not so that cache conflict and cache error occur substantially in spite of that cache conflict or cache error occurs formally, is approximately similar to a procedure allocation optimization disclosed in Japanese Patent Application Laid-open No. Hei 11-232117, therefore, explanations thereof are omitted.

In a step SA7, the linker 36, based on the allocation information stored in the second information storing section 39, by linking the re-allocable object program capable of allocating each procedure and the re-allocable library capable of allocating each procedure, generates an executable final object program and stores it in the fourth program storing section 34, and then a series of processes is finished.

As described above, with this configuration, the memory access information generating section 37b generates memory access information of instruction code actually fetched by the program executing section 37a and, based on the memory access information, the procedure effective area judging section 40a determines a procedure effective area and the cache optimizing section 40b executes allocation optimization for all procedures using the procedure effective area as the optimization unit, therefore, it is possible to prevent cache conflict among various procedures on a cache memory and cache error of procedures used frequently from occurring more substantially. As a result, it is possible to increase an execution speed when a computer or a CPU executes an object program.

Thus, it is possible to use the program conversion apparatus according to the first embodiment for program conversion of a program used units tightly requiring prevention of cache conflict and cache error of procedures as an unit processing a large quantity of data at high speed such as a mobile apparatus.

Also, with the program conversion apparatus of the first embodiment, cases increase in that cache conflict and cache error of procedures can be prevented from occurring.

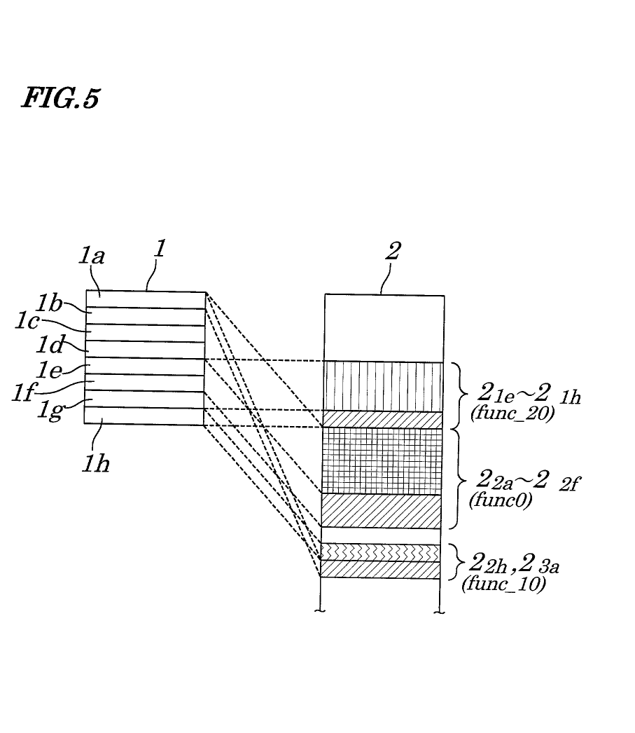

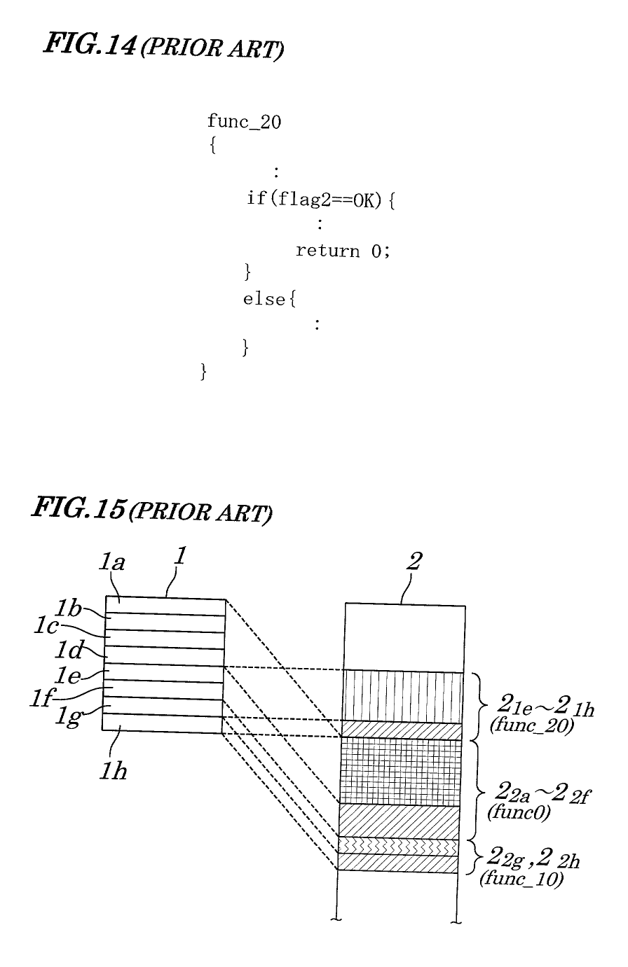

Hereunder, in order to compare the conventional technique with the first embodiment, an example is explained with reference to FIG. 5 and FIG. 12 to FIG. 15.

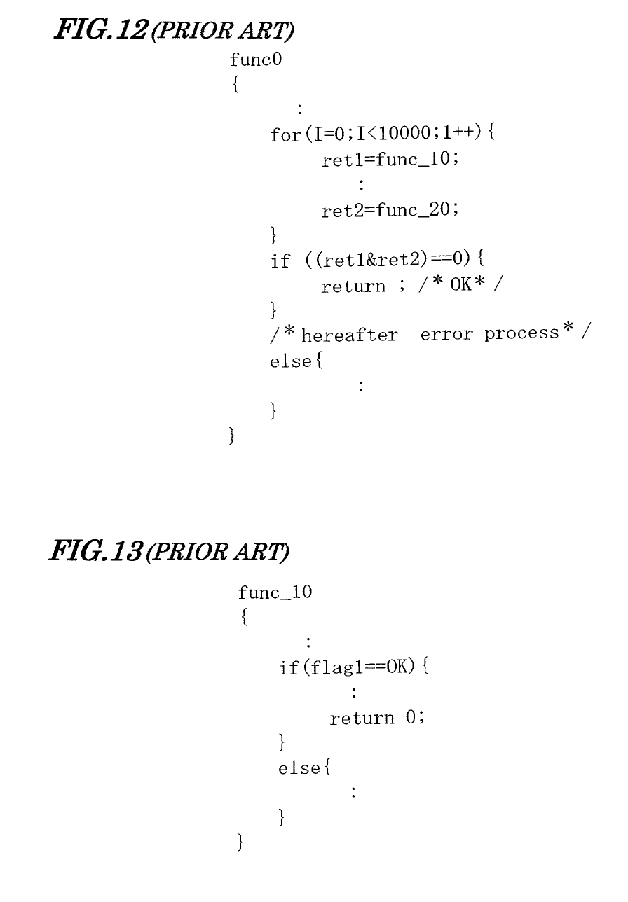

When the source program shown in FIG. 12 to FIG. 15 is converted into a final object program by the program conversion apparatus of the first embodiment, the final object program is stored in main memory 2 as shown in FIG. 5. As understood from FIG. 5, cache conflict occurs in cache line 1e and cache line if between the procedure “func0” and procedure “func_20” formally, cache conflict occurs in the cache line 1a between procedure “func0” and procedure “func_10”, and a conflict occurs in the cache line 1h between procedure “func_10” and procedure “func_20”.

However, substantially, in other words, when attention is paid to procedure effective areas, procedure effective areas of the procedure “func0” are stored in a storage area 2₂ₐ to a storage area 2_{2f}, procedure effective areas of the procedure “func_10” are stored in a storage area 2₂ₕ and a storage area 2₃ₐ, and procedure effective areas of the procedure “func_20” are stored in a storage area 2₁ₑ to a storage area 2₁ₕ, and no cache conflict occurs.

Accordingly, in the first embodiment, no cache conflict and no cache error occurs, therefore, when all processes of the procedure “func0” are executed once, it takes 2,000,200 clocks.

On the other hand, when the same source program is converted into a final object program by the conventional program conversion apparatus and all processes of the procedure “func0”, cache errors of 20,000 occur with a loss of 1,000,000 clocks.

In other words, according to the first embodiment, an execution time is shorten by 1,000,000 clocks.

### Second Embodiment

Next, explanations will be given of the second embodiment according to the present invention.

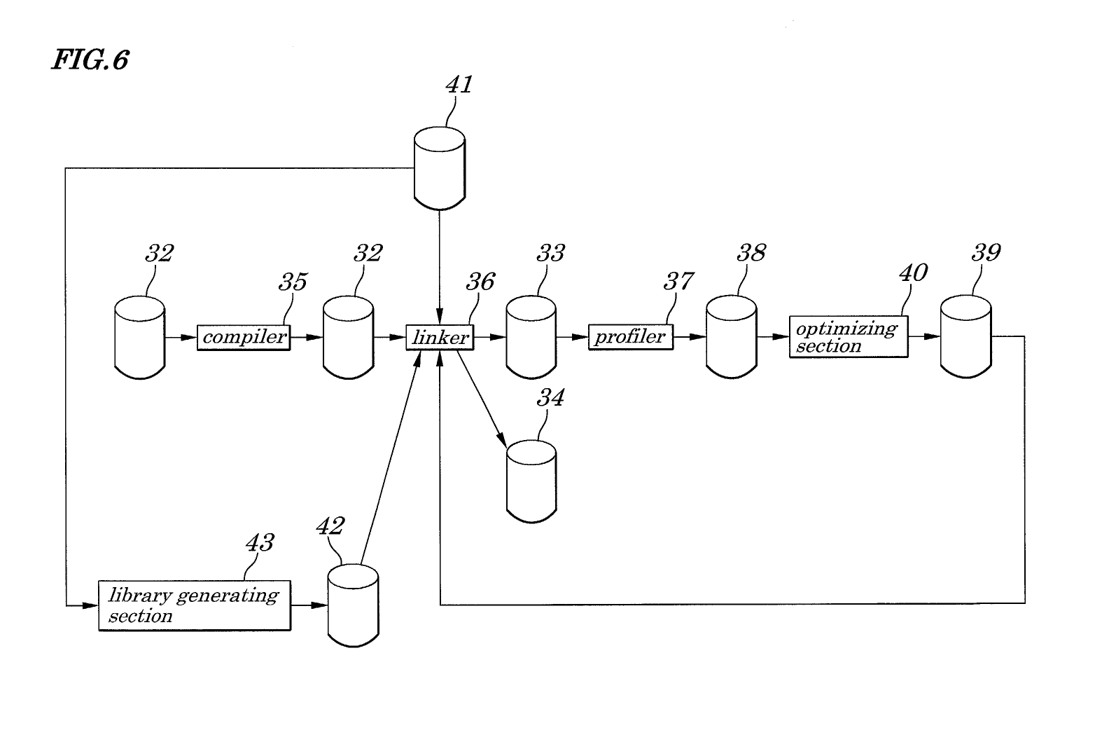

FIG. 6 is a block diagram showing an electrical configuration of a program conversion apparatus according to the second embodiment of the present invention. In FIG. 6, same numerals are given to sections corresponding in FIG. 1 and explanations thereof are omitted. In the program conversion apparatus shown in FIG. 6, re-allocable library stored in first library storing section 41 is supplied to the linker 36.

The second embodiment is configured as shown in FIG. 6 since there are following reasons. In other words, when a number of re-allocable libraries are large, it takes time that library generating section 43 converts all re-allocable libraries stored in the first library storing section 41 into re-allocable libraries capable of allocating each procedure. Then, concerning some of re-allocable libraries, the that the library generating section 43 does not convert some of re-allocable libraries into re-allocable libraries capable of allocating each procedure, however, the linker 36 directly links some of re-allocable libraries with re-allocable object programs capable of allocating each procedure. In this case, the linker 36 may judge which re-allocable library is directly supplied to the linker 36 based on, for example, dynamic information stored in first information storing section 38 or a code size of each procedure.

Therefore, it is possible to obtain a final object program within a shorter time shorter than the first embodiment.

### Third Embodiment

Next, explanations will be given of the third embodiment according to the present invention.

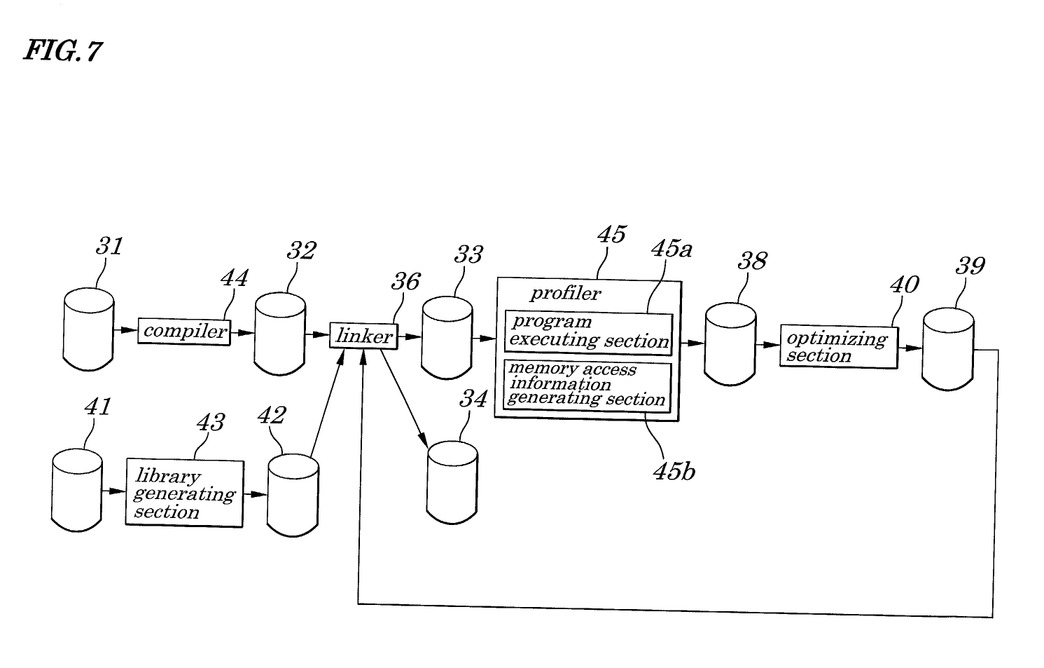

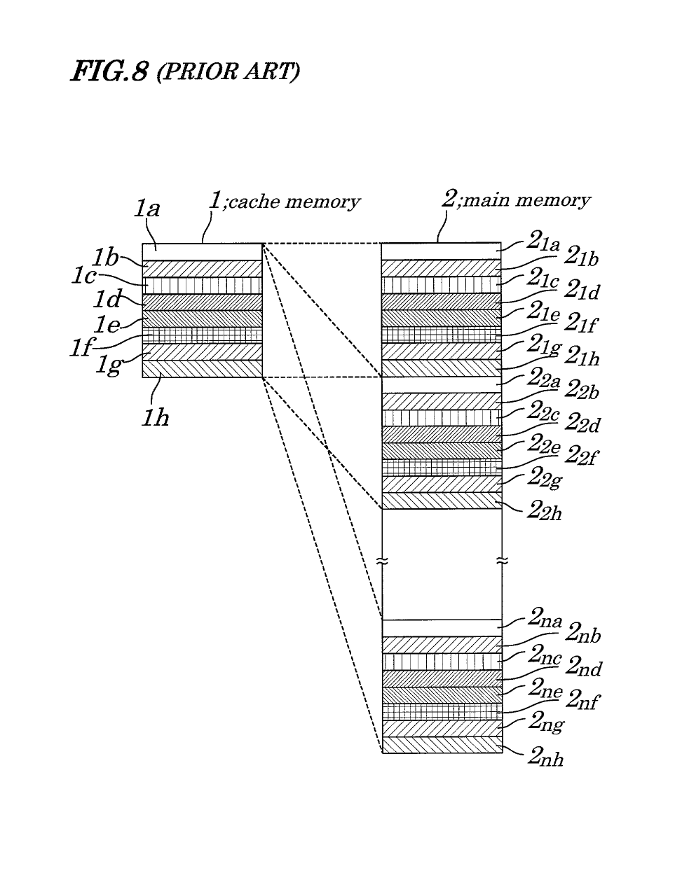

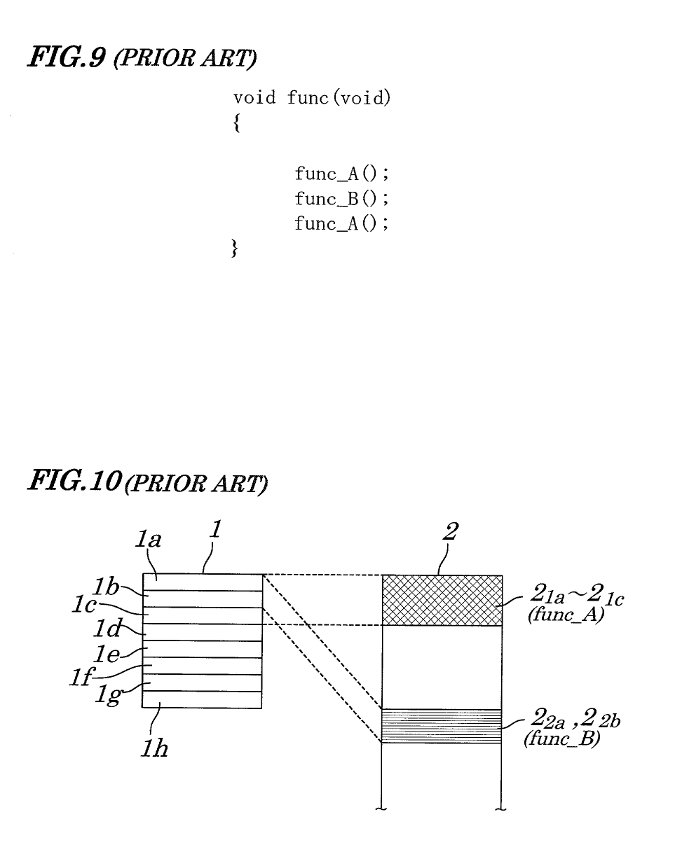

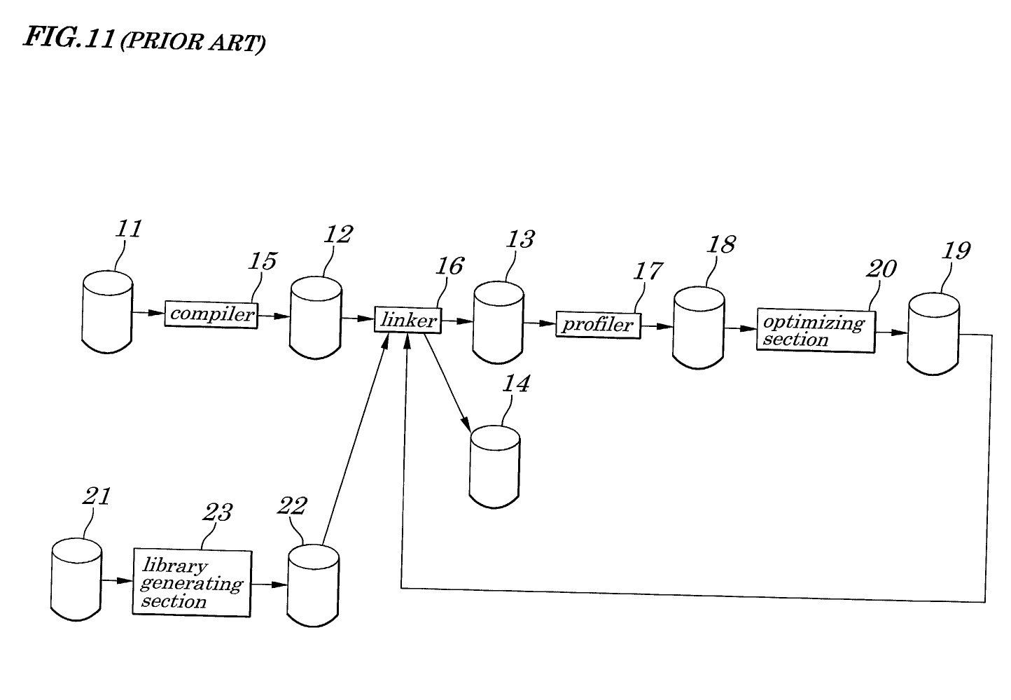

FIG. 7 is a block diagram showing an electrical configuration of a program conversion apparatus according to the third embodiment of the present invention. In FIG. 7, same numerals are given to sections corresponding in FIG. 1 and explanations thereof are omitted. In the program conversion apparatus shown in FIG. 7, a compiler 44 and a profiler 45 are provided instead of compiler 35 and profiler 37.

The profiler 45 is mainly provided with a program executing section 45a and a memory access information generating section 45b.

The memory access information generating section 45b functions similarly to memory access information generating section 37b shown in FIG. 1, however, the program executing section 45a is different from the program executing section 37a shown in FIG. 1, as it has no function for collecting dynamic information and merely reads an executable temporary object program stored in a third program storing section 33 and executes it.

Instead of the program executing section 45a, the compiler 44, in compiling a source program into an executable temporary object program, inserts a count code into the temporary object program for counting a frequency of procedures actually executed when the program executing section 45a executes the temporary object program. With this operation, the program executing section 45a, by executing the temporary object program, can collect dynamic information including a calling relationship among procedures, a frequency of calling each procedure and stores the dynamic information in a first information storing section 38.

In addition, operation of the program conversion apparatus of the third embodiment is approximately similar to that of the first embodiment except that process of step SA2 and process of step SA4 in the flowchart shown in FIG. 2 are different, therefore, explanations of other processes are omitted.

In other words, in the process of the step SA2, the compiler 44, while inserting count code, compiles source program read from a first program storing section 31 into an executable temporary object program and stores it in a second program storing section 32.

In addition, in process of step SA4, the program executing section 45a executes the temporary object program read from the third program storing section 33, and the count code is inserted in the temporary object program, therefore, the dynamic information including a calling relationship among procedures, the frequency of calling each procedure, and a like is collected and is stored in the first information storing section 38.

As described above, according to the third embodiment, though the program executing section 45a does not collect dynamic information, effects approximately equal to the first embodiment can be obtained.

It is apparent that the present invention is not limited to the above embodiments but may be changed and modified without departing from the scope and spirit of the invention.

For example, in the first embodiment to the third embodiment, an example is shown in which the present invention is applied when a final object program is generated from a source program, however, the present invention is not limited to this and may be applied to a case in which plural source programs are respectively compiled into re-allocable object programs and then the re-allocable object programs are linked by the linker 36 in order to generate a final object program.

Also, in the first embodiment to the third embodiment, an example is shown in which the first program storing section 31 to the fourth program storing section 34 and the first information storing section 38 and the second information storing section 39 and the first library storing section 41 and the second library storing section 42 are each made by a separated storage medium, however, the present invention is not limited to this and, for example, they may be arrange in different memory areas in a same storage medium. In this case, respective subjects to be stored in the first program storing section 31 to the fourth program storing section 34 and the first library storing section 41 and the second library storing section 42 are programs and libraries requiring large memory capacities, therefore, in the first program storing section 31 to the fourth program storing section 34 and the first library storing section 41 and the second library storing section 42 may be made up of an FD, an HD or a CD-ROM. Subjects to be stored in the first information storing section 38 and the second information storing section 39 are data requiring comparatively little memory capacities, therefore, the first information storing section 38 and the second information storing section 39 may be made up of a semiconductor memory such as a ROM or a RAM.

Also, in the first embodiment to the third embodiment, an example is shown in which the memory access information generating section 37b and the memory access information generating section 45b generate the memory access information whenever the program executing section 37a fetches an instruction code from the third program storing section 33, however, the present invention is not limited to this and, for example, may be applied to a case in which memory access information is generated from an address of a branch start or a branch destination only when an instruction code concerning a process to change a flow of a program such as a jump instruction is fetched. In this case, it is possible to shorten a time for program conversion.

Also, in the first embodiment to the third embodiment, the procedure effective area is used as an optimization unit, and an example is shown in which a unit of several instruction codes to be arranged is a procedure. However, it is unnecessary that a unit of several instruction codes to be arranged is a procedure and, for example, in a case of a “if-else” sentence, processes after “if” before “else” or processes after “else” are used as a basic block and the basic block may be used as a unit of several instruction codes to be arranged. In this case, it is possible to execute optimization not so that a cache conflict and a cache error of procedures occur in fact.

Also, in the first embodiment to the third embodiment, an example is shown in which the program conversion apparatus is provided with the first library storing section 41 storing a re-allocable library including standard library procedure, runtime library procedure and user library procedure and the library generating section 43 converting the re-allocable library stored in the first library storing section 41 into a re-allocable library capable of being arranged for each procedure and storing the re-allocable library capable of being arranged for each procedure in the second library storing section 42. However, the present invention is not limited to this, and the re-allocable library capable of being arranged for each procedure may be previously stored in the second library storing section 42. In this case, it is possible to shorten a time for program conversion.

Furthermore, in the first embodiment to the third embodiment, an example is shown in which each section is made by hardware, however, the present invention is not limited to this. In other words, the above-mentioned program conversion apparatus is a computer having a CPU (Central Processing Unit), internal storage memories such as a ROM and a RAM, external storage memories such as an FDD (Floppy Disc Drive), an HDD (Hard Disk Drive) or a CD-ROM drive, an output section and an input section, and the compiler 35 or the compiler 44, the linker 36, the profiler 37 or the profiler 45 and the library generating section 43 are provided by the CPU and these functions may be stored as a program conversion program in a semiconductor memory such as a ROM and storage medium such as an FD, an HD or a CD-ROM. In this case, the internal storage memories or the external storage memories may be the first program storing section 31 to the fourth program storing section 34, the first information storing section 38 and the second information storing section 39 and the first library storing section 41 and the second library storing section 42, and the program conversion program is read from storage medium and controls an operation of the CPU. When the program conversion program is started, the CPU functions as the compiler 35 or the compiler 44, the linker 36, the profiler 37 or the profiler 45 and the library generating section 43 and the above-mentioned processes are executed by control of the program conversion program.

It is apparent that the present invention is not limited to the above embodiments but may be changed and modified without departing from the scope and spirit of the invention.

What is claimed is:

1. A program conversion method of converting a source program written in a programming language into a first object program written in a language executable by a computer and a central processing unit, said program conversion method comprising:
a first step of converting said source program into a second object program;
a second step, while executing said second object program, of collecting information concerning a procedure, a function or a subroutine used in said source program and of generating memory access information showing a relative position of an instruction code actually taken out in said procedure, said function or said subroutine;
a third step, concerning all procedures, all functions or all subroutines in said second object program, of determining an area as said effective area when said area exists in which there are sequential instruction codes corresponding to said memory access information and of determining an minimum area including plural areas as an effective area when said plural areas exist in which there are sequential instruction codes corresponding to said memory access information; and
a fourth step, based on said memory access information, of determining which storage area keeps said procedure, said function or said subroutine in a main memory in which said first object program is stored when said first object program is used by said computer and said central processing unit, not so as to generate a cache conflict of said effective areas on a cache line in said computer and said central processing unit.

2. The program conversion method according to claim 1, wherein said procedure, said function or said subroutine includes at least one defined by a user in said source program, one already defined and inspected by said user, one previously prepared in a processing system in said programming language and one previously prepared in an instruction code format.

3. The program conversion method according to claim 1, wherein said memory access information includes information showing a frequency of actual calls for said procedure, said function or said subroutine and information showing a relationship for calling said procedure, said function or said subroutine each other, obtained by executing said second object program.

4. The program conversion method according to claim 1, wherein said memory access information is generated only when an instruction code concerning a process changing a flow of said second object program is taken out.

5. A program conversion method of converting a source program written in a programming language into a first object program written in a language executable by a computer and a central processing unit, said program conversion method comprising:
a first step of converting said source program into a second program and of generating a third object program by converting a procedure, a function or a subroutine defined by a user in said source program concerning said second object program into a procedure, a function or a subroutine storable in any memory area of an main memory in which said first object program is stored when said first object program is used in said computer or said central processing unit;
a second step of generating a fourth object program by linking said procedure, said function or said subroutine in any memory area in said main memory which is at least a part of one defined and inspected by said user, one previously prepared in a processing system in said programming language or one previously prepared in an instruction code format in said procedure, said function and subroutine used in said source program with said third object program;
a third step, while executing said fourth object program, of collecting dynamic information including information showing a frequency of actual calls for said procedure, said function or said subroutine and information showing a relationship of calling said procedure, said function or subroutine each other and of generating memory access information showing a relative position in said procedure, said function or said procedure including an instruction code actually taken out;
a fourth step, concerning all procedures, all functions or all subroutines in said fourth object program, of determining an area as an effective area when said area exists in which there are sequential instruction codes corresponding to said memory access information and of determining a minimum area including plural areas as an effective area when said plural areas exist in which there are sequential instruction codes corresponding to said memory access information;
a fifth step, based on said dynamic information, of determining which storage area keeps said procedure, said function or said subroutine in said main memory in which said first object program is stored when said first object program is used by said computer and said central processing unit, not so as to generate a cache conflict of said effective areas on a cache line in said computer and said central processing unit and of generating allocation information; and
a sixth step, based on said allocation information, of generating said first object program by linking a converted procedure, a converted function or a converted subroutine storable in any memory area in said main memory which is at least a part of one defined and inspected by said user, one previously prepared in a processing system in said programming language or one previously prepared in an instruction code format in said procedure, said function or subroutine used in said source program with said third object program.

6. The program conversion method according to claim 5, wherein in said third step, said memory access information is generated only when said instruction code concerning a process changing a flow of said second object program is taken out.

7. A program conversion method of converting a source program written in a programming language into a first object program written in a language executable by a computer and a central processing unit, said program conversion method comprising:
a first step of converting said source program into a second object program and of generating a third object program by inserting a code for counting a frequency of actual calls for a procedure, a function or a subroutine when said second object program is executed and by converting said procedure, said function or said subroutine defined by a user in said source program concerning said second object program into a procedure, a function or a subroutine storable in any memory in a main memory in which said first object program is stored when said first object program is used by said computer or said central processing unit;
a second step of generating a fourth object program by linking said storable procedure, said storable function or said storable subroutine storable in any memory area in said main memory which is at least a part of one defined and inspected by a user, one previously prepared in a processing system in said programming language or one previously prepared in an instruction code format in said procedure, said function or said subroutine used in said source program with said third object program;
a third step, while executing said fourth object program, of collecting dynamic information including information showing a frequency of actual calls for said procedure, said function or said subroutine and information showing a relationship of calling said procedure, said function or said subroutine each other and of generating memory access information showing a relative position in said procedure, said function or said procedure including an instruction code actually taken out;
a fourth step, concerning all procedures, all functions or all subroutines in said fourth object program, of determining an area as said effective area when said area exists in which there are sequential instruction codes corresponding to said memory access information and of determining a minimum area including plural areas as an effective area when said plural areas exist in which there are sequential instruction codes corresponding to said memory access information;
a fifth step, based on said dynamic information, of determining which storage area keeps said procedure, said function or said subroutine in said main memory in which said first object program is stored when said first object program is used by said computer and said central processing unit, not so as to generate a cache conflict of said effective areas on a cache line in said computer and said central processing unit and of generating allocation information; and
a sixth step, based on said allocation information, of generating said first object program by linking said storable procedure, said storable function or said storable subroutine in any memory area in said main memory which is at least a part of one defined and inspected by said user, one previously prepared in said processing system in said programming language or one previously prepared in said instruction code format in said procedure, said function or subroutine used in said source program with said third object program.

8. The program conversion method according to claim 7, wherein in said third step, said memory access information is generated only when said instruction code concerning a process changing a flow of said second object program is taken out.

9. A program conversion apparatus for converting a source program written in a programming language into a first object program written in a language executable by a computer and a central processing unit, said program conversion apparatus comprising:
a first program converting section for converting said source program into a second object program;
a program executing section, while executing said second object program, for collecting information concerning a procedure, a function or a subroutine used in said source program and for generating memory access information showing a relative position in a procedure, a function or a subroutine including an instruction code actually taken out;
an effective area judging section, concerning all procedures, all functions or all subroutines in said second object program, of judging an area as said effective area when said area exists in which there are sequential instruction codes corresponding to said memory access information and of judging a minimum area including plural areas as an effective area when said plural areas exist in which there are sequential instruction codes corresponding to said memory access information; and
a second program converting section, based on said information, for determining which memory in a main memory keeps said procedure, said function or said subroutine, said main memory storing said first object program when said first object program is used by said computer or said central processing unit, not so as to generate a cache conflict of said effective areas on a cache line in said computer or said central processing unit.

10. The program conversion apparatus according to claim 9, wherein said procedure, said function or said subroutine includes at least one defined by a user in said source program, one already defined inspected by said user, one prepared in a processing system in said programming language and which is prepared in an instruction code format.

11. The program conversion apparatus according to claim 9, wherein said memory access information includes information showing a frequency of actual calls for said procedure, said function or said subroutine and information showing a relationship for calling said procedure, said function or said subroutine.

12. The program conversion apparatus according to claim 9, wherein said program executing section generates said memory access information only when said instruction code concerning a process changing a flow of said second object program.

13. A program conversion apparatus for converting a source program written in a programming language into a first object program written in a language executable by a computer and a central processing unit, said program conversion apparatus comprising:
a program converting section for converting said source program into a second object program and, concerning said second object program, by converting a procedure, a function or a subroutine defined by a user in said source program into a procedure, a function or a subroutine storable in any memory area of a main memory in which said first object program is stored when said first object program is processed by said computer or said central processing unit, of generating a third object program;
a linker for linking said storable procedure, said storable function or said storable subroutine in any memory area in said main memory which is at least a part of one defined and inspected by a user, one previously prepared in a processing system in said programming language or one previously prepared in an instruction code format in said procedure, said function or subroutine used in said source program with said third object program and for generating a fourth object program;
a memory access information generating section, while executing said fourth object program, for collecting dynamic information including information showing a frequency actual calls for said procedure, said function or said subroutine and information showing a relationship of calling said procedure, said function or said subroutine and for generating memory access information showing a relative position in a procedure, said function or said subroutine including an instruction code actually taken out;
an effective area judging section for concerning all procedures, all functions or all subroutines in said fourth object program, of judging an area as an effective area when said area exists in which there are sequential instruction codes corresponding to said memory access information and of judging a minimum area including plural areas as said effective area when said plural areas exist in which there are sequential instruction codes corresponding to said memory access information; and
an optimizing section, based on said dynamic information, for determining which memory in said main memory keeps said procedure, said function or said subroutine, said main memory storing said first object program when said first object program is used by said computer or said central processing unit, not so as to generate a cache conflict of said effective areas on a cache line in said computer or said central processing unit and for generating allocation information; and
said linker, based on said allocation information, for linking said storable procedure, said storable function or said storable subroutine in any memory area in said main memory which is at least a part of one defined and inspected by said user, one previously prepared in said processing system in said programming language or one previously prepared in an instruction code format in said procedure, said function or said subroutine used in said source program with said fourth object program and for generating said first object program.

14. The program conversion apparatus according to claim 13, wherein said program executing section generates said memory access information only when said instruction code concerning a process changing a flow of said second object program.

15. A program conversion apparatus for converting a source program written in a programming language into a first object program written in a language executable by a computer and a central processing unit, said program conversion apparatus comprising:
a program converting section for converting said source program in to a second object program, for inserting a code counting a frequency of actual calls for a procedure, a function or a subroutine when said second object program is executed, and concerning said second object program, by converting said procedure, said function or said subroutine defined by a user in said source program into a procedure, a function or a subroutine storable in any memory area of a main memory in which said first object program is stored when said first object program is processed by said computer or said central processing unit, of generating a third object program;
a linker for linking said storable procedure, said storable function or said storable subroutine in any memory area in said main memory which is at least a part of one defined and inspected by said user, one previously prepared in a processing system in said programming language or one previously prepared in an instruction code format in said procedure, said function or subroutine used in said source program with said third object program and for generating a fourth object program;
a memory access information generating section, while executing said fourth object program, for collecting dynamic information including information showing a frequency of actual calls for said procedure, said function or said subroutine and information showing a relationship of calling said procedure, said function or said subroutine and for generating memory access information showing a relative position in a procedure, a function or a subroutine including an instruction code actually taken out; and
an effective area judging section, concerning all procedures, all functions or all subroutines in said fourth object program, for judging an area as said effective area when said area exists in which there are sequential instruction codes corresponding to said memory access information and for judging a minimum area including plural areas as an effective area when said plural areas exist in which there are sequential instruction codes corresponding to said memory access information; and
an optimizing section, based on said dynamic information, for determining which memory in said main memory keeps said procedure, said function or said subroutine, said main memory storing said first object program when said first object program is used by said computer or said central processing unit, not so as to generate a cache conflict of said effective areas on a cache line in said computer or said central processing unit and for generating allocation information; and
said linker, based on said allocation information, for linking said storable procedure, said storable function or said storable subroutine in any memory area in said main memory which is at least a part of one defined and inspected by said user, one previously prepared in said processing system in said programming language or one previously prepared in an instruction code format in said procedure, said function or subroutine used in said source program with said fourth object program and for generating said first object program.

16. The program conversion apparatus according to claim 15, wherein said program executing section generates said memory access information only when said instruction code concerning a process changing a flow of said second object program.

17. A storage medium storing a program conversion program to cause a computer to carry out a program conversion method of converting a source program written in a programming language into a first object program written in a language executable by a computer and a central processing unit, said program conversion method comprising:
a first step of converting said source program into a second object program;
a second step, while executing said second object program, of collecting information concerning a procedure, a function or a subroutine used in said source program and of generating memory access information showing a relative position of an instruction code actually taken out in said procedure, said function or said subroutine;
a third step, concerning all procedures, all functions or all subroutines in said second object program, of determining an area as said effective area when said area exists in which there are sequential instruction codes corresponding to said memory access information and of determining an minimum area including plural areas as an effective area when said plural areas exist in which there are sequential instruction codes corresponding to said memory access information; and
a fourth step, based on said memory access information, of determining which storage area keeps said procedure, said function or said subroutine in a main memory in which said first object program is stored when said first object program is used by said computer and said central processing unit, not so as to generate a cache conflict of said effective areas on a cache line in said computer and said central processing unit.

18. A storage medium storing a program conversion program to cause a computer to carry out a program conversion method of converting a source program written in a programming language into a first object program written in a language executable by a computer and a central processing unit, said program conversion method comprising:
a first step of converting said source program into a second program and of generating a third object program by converting a procedure, a function or a subroutine defined by a user in said source program concerning said second object program into a procedure, a function or a subroutine storable in any memory area of an main memory in which said first object program is stored when said first object program is used in said computer or said central processing unit;
a second step of generating a fourth object program by linking said procedure, said function or said subroutine in any memory area in said main memory which is at least a part of one defined and inspected by said user, one previously prepared in a processing system in said programming language or one previously prepared in an instruction code format in said procedure, said function and subroutine used in said source program with said third object program;
a third step, while executing said fourth object program, of collecting dynamic information including information showing a frequency of actual calls for said procedure, said function or said subroutine and information showing a relationship of calling said procedure, said function or subroutine each other and of generating memory access information showing a relative position in said procedure, said function or said procedure including an instruction code actually taken out;
a fourth step, concerning all procedures, all functions or all subroutines in said fourth object program, of determining an area as an effective area when said area exists in which there are sequential instruction codes corresponding to said memory access information and of determining a minimum area including plural areas as an effective area when said plural areas exist in which there are sequential instruction codes corresponding to said memory access information;
a fifth step, based on said dynamic information, of determining which storage area keeps said procedure, said function or said subroutine in said main memory in which said first object program is stored when said first object program is used by said computer and said central processing unit, not so as to generate a cache conflict of said effective areas on a cache line in said computer and said central processing unit and of generating allocation information; and
a sixth step, based on said allocation information, of generating said first object program by linking a converted procedure, a converted function or a converted subroutine storable in any memory area in said main memory which is at least a part of one defined and inspected by said user, one previously prepared in a processing system in said programming language or one previously prepared in an instruction code format in said procedure, said function or subroutine used in said source program with said third object program.

19. A storage medium storing a program conversion program to cause a computer to carry out a program conversion method of converting a source program written in a programming language into a first object program written in a language executable by a computer and a central processing unit, said program conversion method comprising:
a first step of converting said source program into a second object program and of generating a third object program by inserting a code for counting a frequency of actual calls for a procedure, a function or a subroutine when said second object program is executed and by converting said procedure, said function or said subroutine defined by a user in said source program concerning said second object program into a procedure, a function or a subroutine storable in any memory in a main memory in which said first object program is stored when said first object program is used by said computer or said central processing unit;
a second step of generating a fourth object program by linking said storable procedure, said storable function or said storable subroutine storable in any memory area in said main memory which is at least a part of one defined and inspected by a user, one previously prepared in a processing system in said programming language or one previously prepared in an instruction code format in said procedure, said function or said subroutine used in said source program with said third object program;
a third step, while executing said fourth object program, of collecting dynamic information including information showing a frequency of actual calls for said procedure, said function or said subroutine and information showing a relationship of calling said procedure, said function or said subroutine each other and of generating memory access information showing a relative position in said procedure, said function or said procedure including an instruction code actually taken out;
a fourth step, concerning all procedures, all functions or all subroutines in said fourth object program, of determining an area as said effective area when said area exists in which there are sequential instruction codes corresponding to said memory access information and of determining a minimum area including plural areas as an effective area when said plural areas exist in which there are sequential instruction codes corresponding to said memory access information;
a fifth step, based on said dynamic information, of determining which storage area keeps said procedure, said function or said subroutine in said main memory in which said first object program is stored when said first object program is used by said computer and said central processing unit, not so as to generate a cache conflict of said effective areas on a cache line in said computer and said central processing unit and of generating allocation information; and
a sixth step, based on said allocation information, of generating said first object program by linking said storable procedure, said storable function or said storable subroutine in any memory area in said main memory which is at least a part of one defined and inspected by said user, one previously prepared in said processing system in said programming language or one previously prepared in said instruction code format in said procedure, said function or subroutine used in said source program with said third object program.

20. A program conversion program to cause a computer to carry out a program conversion method of converting a source program written in a programming language into a first object program written in a language executable by a computer and a central processing unit, said program conversion method comprising:
a first step of converting said source program into a second object program;
a second step, while executing said second object program, of collecting information concerning a procedure, a function or a subroutine used in said source program and of generating memory access information showing a relative position of an instruction code actually taken out in said procedure, said function or said subroutine;
a third step, concerning all procedures, all functions or all subroutines in said second object program, of determining an area as said effective area when said area exists in which there are sequential instruction codes corresponding to said memory access information and of determining an minimum area including plural areas as an effective area when said plural areas exist in which there are sequential instruction codes corresponding to said memory access information; and
a fourth step, based on said memory access information, of determining which storage area keeps said procedure, said function or said subroutine in a main memory in which said first object program is stored when said first object program is used by said computer and said central processing unit, not so as to generate a cache conflict of said effective areas on a cache line in said computer and said central processing unit.
